(19) United States
(12) Patent Application Publication
(10) Pub. No.: US 2024/0290069 A1
(43) Pub. Date: Aug. 29, 2024

(54) CLUSTER-BASED AND AUTONOMOUS FINDING OF REFERENCE INFORMATION

(71) Applicant: LEAN AI TECHNOLOGIES LTD., Tel Aviv (IL)

(72) Inventor: Tom TABAK, Tel Aviv (IL)

(73) Assignee: LEAN AI TECHNOLOGIES LTD., Tel Aviv (IL)

(21) Appl. No.: 18/176,385

(22) Filed: Feb. 28, 2023

(51) Int. Cl. G06V 10/762; G06V 10/44; G06V 10/74; G06V 10/82

(52) U.S. Cl. CPC G06V 10/762; G06V 10/44; G06V 10/761; G06V 10/82

(57) ABSTRACT

A method for cluster-based and autonomous finding of reference information, the method may include obtaining a group of untagged images, each untagged image captures an instance of an item; wherein at least some of the untagged images capture different instances of the item; obtaining multiple sets of item pixels from the untagged images of the group, each set originated from an untagged image of the group and comprises multiple item pixels; determining item features of the item for each set, based on the multiple item pixels of the set and; repeating, until reaching an end condition the steps of: (a) selecting some of the sets as centroids; (b) clustering the item features of the some of the sets to provide clusters, wherein the clustering is based, at least in part, on the centroids; and (c) removing members of a cluster that has less members than another cluster; and defining untagged images that are associated with a member of any remaining cluster as reference images or as reference image candidates.

### BACKGROUND

Defect detection is a process that involve acquiring images of evaluated objects and processing the images to detect defects. A common method for defect detection include comparing an image of an evaluated object to an image of a reference object.

It may be beneficial to compare the evaluated object to a reference object that is defect free—but generating an image of a defect free reference object may also be time and resource consuming. Comparing the inspected object to an arbitrary reference object may provide ambiguous results—as a different between the evaluated object and the reference object may result from defects of the evaluated object or the reference object.

There is a growing need to provide a cost-effective method for cluster-based and autonomous finding of reference information.

### SUMMARY

There is provided a method, a system and/or a non-transitory computer readable medium for cluster-based and autonomous finding of reference information.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a clustering iteration;

FIG. 3 illustrates an example of a clustering iteration; and

FIG. 4 illustrates an example of a clustering iteration.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of the units may be implemented in hardware and/or code, instructions and/or commands stored in a non-transitory computer readable medium, may be included in a vehicle, outside a vehicle, in a mobile device, in a server, and the like.

The vehicle may be any type of vehicle that a ground transportation vehicle, an airborne vehicle, and a water vessel.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There may be provide a method, system and a non-transitory computer readable medium for cluster-based and autonomous finding of reference information.

The method, system and a non-transitory computer readable medium can process any amount of images of instances of an item-without needing to tag the images.

There may be any number of instances of the item. If the item is, for example, an object then the different instances may include different objects that should (if manufactured under ideal defect-free conditions) be the same.

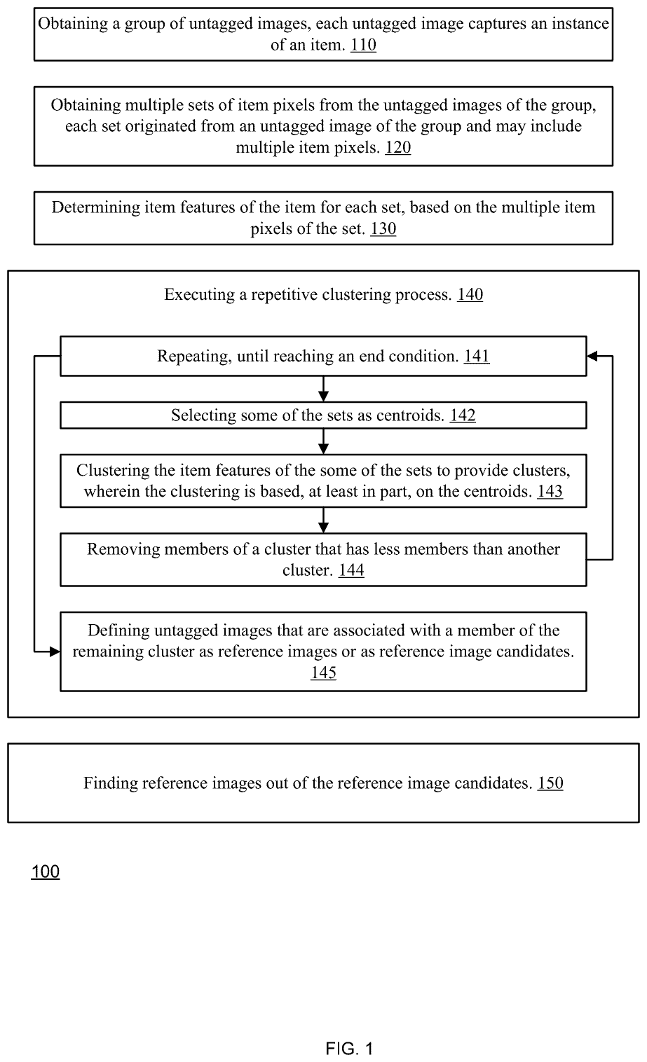

FIG. 1 illustrates an example of method 100 for cluster-based and autonomous finding of reference information.

Method 100 may start by step 110 of obtaining a group of untagged images, each untagged image captures an instance of an item. At least some of the untagged images capture different instances of the item.

Step 110 may be followed by step 120 of obtaining multiple sets of item pixels from the untagged images of the group, each set originated from an untagged image of the group and may include multiple item pixels.

Step 120 may be followed by step 130 of determining item features of the item for each set, based on the multiple item pixels of the set.

Step 130 may be followed by step 140 of executing a repetitive clustering process.

Step 140 may include step 141 of repeating, until reaching an end condition, steps 142, 143, and 144.

Step 142 may include selecting some of the sets as centroids. Step 142 may include selecting a first centroid in a random manner and selecting a second centroid based on a distance to the first centroid. The distance may be calculated in any manner. The second centroid may be the most distant centroid from the first centroid. For example—the second centroid may be the most dissimilar (by measure of cosine similarity) from the first centroid. More than two centroids may be selected.

Step 143 may include clustering the item features of the some of the sets to provide clusters, wherein the clustering is based, at least in part, on the centroids.

Step 144 may include removing members of a cluster that has less members than another cluster.

After completing the repetitions of steps 141-144—jumping to step 145 of defining untagged images that are associated with a member of the remaining cluster as reference images or as reference image candidates.

The end condition may be fulfilled when a number of remaining members is below a predefined member number threshold.

The end condition may be fulfilled when differences between remaining members are below a difference predefined threshold.

The end condition may fulfilled when a variance of the remaining members is below a variance predefined threshold.

Step 140 may be executed by a non-item specific neural network, the non-item specific neural network is pre-trained to perform feature extraction of objects, at least some of the objects differ from the item.

An example of the non-item specific neural network if the Wide ResNet50.

Method 100 may also include step 150 of finding reference images out of the reference image candidates.

Step 150 may include selecting a predefined number of reference images closest to a centroid, selecting reference numbers that are close enough (for example above a similarity threshold) to the centroid, and the like.

The untagged images may be all untagged images associated with any member of the remaining cluster, untagged images associated with only some of the member of the remaining cluster, and the like.

The selection of the reference images of the reference image candidates may be based on distances calculated in a manner illustrated in US provisional patent titled Unsupervised method for anomaly detection in manufacturing that is incorporated herein by reference.

Step 140 may include re-training a non-item specific neural network with the reference image candidates.

The reference images found in step 150 may be used in defect detection or other inspection processes of instances of an item.

Step 150 may be followed by responding to the outcome of step 150. This may include at least one of:
a. Performing an inspection of other instances of the item (for example other manufactured items that should—in an ideal manufacturing process—be identical).
b. Determining a defects in a manufacturing process (of the instances of the item).
c. Finding desired parameters of the manufacturing process.
d. Requesting or instructing a manufacturing machine to alter the manufacturing process.
e. Storing the reference images found in step 150.
f. Sending the reference images.
g. Transmitting the reference images to defect detection systems and/or other inspection systems for use in future inspections and/or defect detection processes.

Method 100 provides an improvement in computer science—as it is effective—may be executed without prior knowledge and/or without historic bias or errors. The method is accurate. The method saves storage and/or computational resources due to its compactness and its simplicity.

Method 100 may be executed by a computerized system that may include one or more processors, wherein each processor is a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. The computerized system may include one or more hardware memory units and/or one or more communication units, and the like.

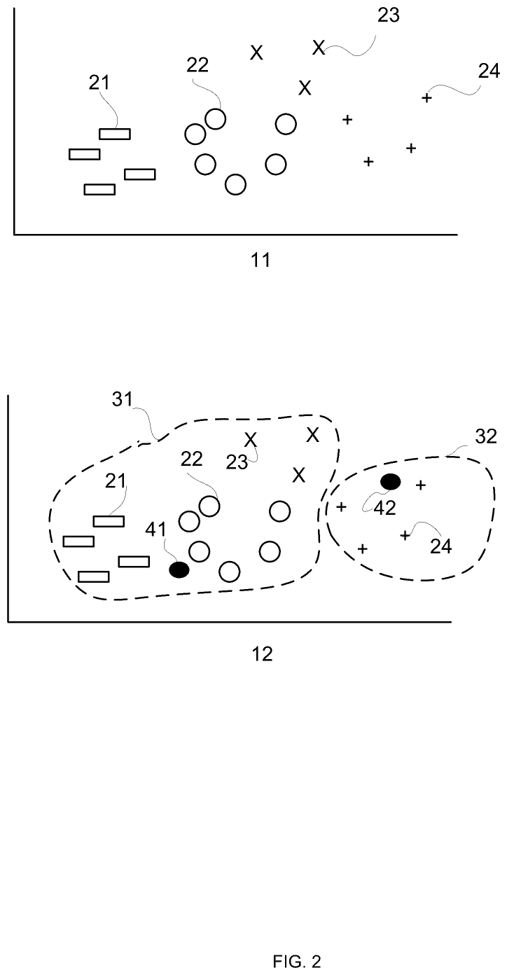

FIGS. 2-4 illustrate examples of clustering iterations.

Graph 11 of FIG. 2 illustrates four types of item features that represent different images—first type item features 21, second type item features 22, third type item features 23 and fourth type of image feature 24.

Graph 12 of FIG. 2 illustrates two clusters centered around two centroids—first cluster 31 centered around first centroid 41 and second cluster 32 centered around centroid 42. The first centroid includes more members than the second centroid—and the members (fourth type of image features 24) of the second centroid are ignored of.

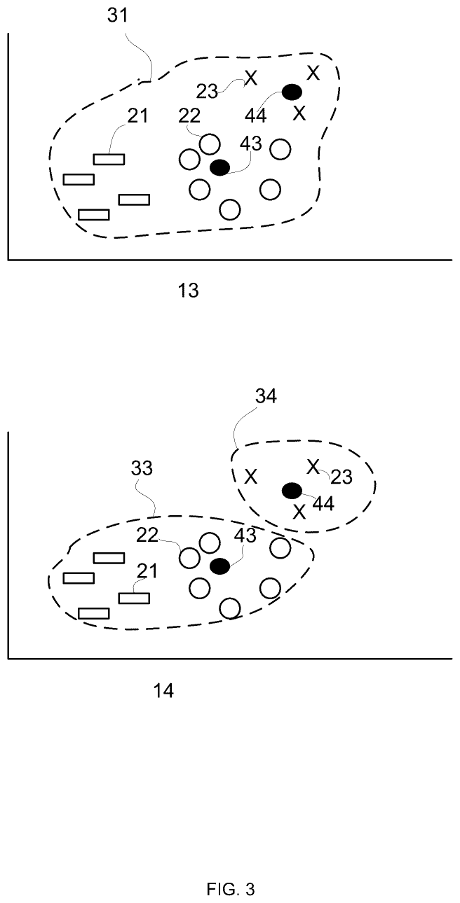

Graph 13 of FIG. 3 illustrates third and fourth centroids 43 and 44 within a space that includes the first cluster 31.

Graph 14 of FIG. 3 illustrates two new clusters centered around two centroids—third cluster 33 centered around third centroid 43 and fourth cluster 34 centered around fourth centroid 44. The third centroid includes more members than the third centroid—and the members (third type of image features 23) of the fourth centroid are ignored of.

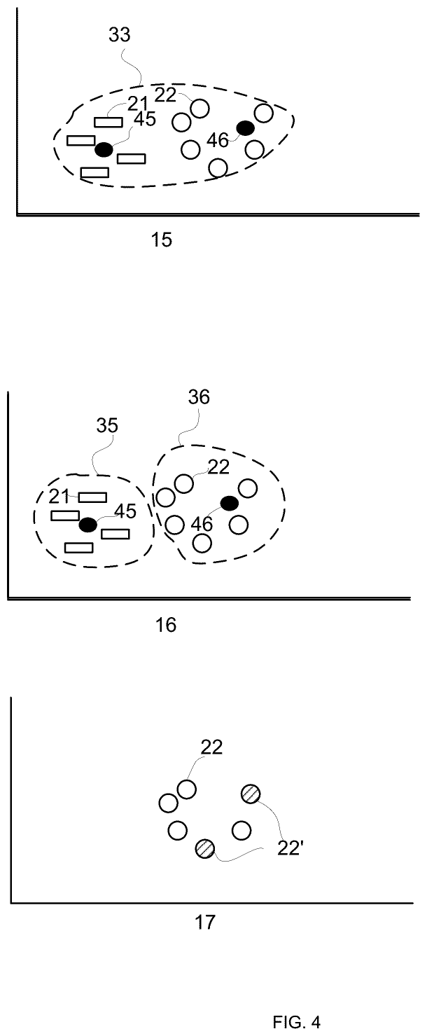

Graph 15 of FIG. 4 illustrates fifth and sixth centroids 45 and 46 within a space that includes the third cluster 33.

Graph 16 of FIG. 4 illustrates two new clusters centered around two centroids—fifth cluster 35 centered around fifth centroid 45 and sixth cluster 36 centered around sixth centroid 46. The sixth centroid includes more members than the fifth centroid—and the members (first type of image features 21) of the fifth centroid are ignored of.

The members (second type of image features 22) are associated with reference images of reference image candidates.

Graph 17 of FIG. 4 illustrates that all of the second type of image features 22 may be reference images—or only some (denoted 22′) may be the reference images.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front.” “back,” “top.” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A method for cluster-based and autonomous finding of reference information, the method comprises:
obtaining a group of untagged images, each untagged image captures an instance of an item; wherein at least some of the untagged images capture different instances of the item;
obtaining multiple sets of item pixels from the untagged images of the group, each set originated from an untagged image of the group and comprises multiple item pixels;
determining item features of the item for each set, based on the multiple item pixels of the set and;
repeating, until reaching an end condition the steps of:
a. selecting some of the sets as centroids;
b. clustering the item features of the some of the sets to provide clusters, wherein the clustering is based, at least in part, on the centroids; and
c. removing members of a cluster that has less members than another cluster;
defining untagged images that are associated with a member of any remaining cluster as reference images or as reference image candidates.

2. The method according to claim 1 wherein the end condition is fulfilled when a number of remaining members is below a predefined member number threshold.

3. The method according to claim 1 wherein the end condition is fulfilled when differences between remaining members are below a difference predefined threshold.

4. The method according to claim 1 wherein the end condition is fulfilled when a variance of the remaining members is below a variance predefined threshold.

5. The method according to claim 1 wherein the selecting comprises selecting a first centroid in a random manner and selecting a second centroid based on a distance to the first centroid.

6. The method according to claim 1 wherein the determining of the item features is executed by a non-item specific neural network, the non-item specific neural network is pre-trained to perform feature extraction of objects, at least some of the objects differ from the item.

7. The method according to claim 1 comprising finding reference images out of the reference image candidates.

8. The method according to claim 7 wherein the determining of the item features is executed by a non-item specific neural network, the non-item specific neural network is pre-trained to perform feature extraction of objects, at least some of the objects differ from the item.

9. The method according to claim 8 comprising re-training a non-item specific neural network with the reference images.

10. A non-transitory computer readable medium for cluster-based and autonomous finding of reference information, the non-transitory computer readable medium stores instructions for:
obtaining a group of untagged images, each untagged image captures an instance of an item; wherein at least some of the untagged images capture different instances of the item;
obtaining multiple sets of item pixels from the untagged images of the group, each set originated from an untagged image of the group and comprises multiple item pixels;
determining item features of the item for each set, based on the multiple item pixels of the set and;
repeating, until reaching an end condition the steps of:
a. selecting some of the sets as centroids;
b. clustering the item features of the some of the sets to provide clusters, wherein the clustering is based, at least in part, on the centroids; and
c. removing members of a cluster that has less members than another cluster;
defining untagged images that are associated with a member of any remaining cluster as reference images or as reference image candidates.

11. The non-transitory computer readable medium according to claim 10 wherein the end condition is fulfilled when a number of remaining members is below a predefined member number threshold.

12. The non-transitory computer readable medium according to claim 10 wherein the end condition is fulfilled when differences between remaining members are below a difference predefined threshold.

13. The non-transitory computer readable medium according to claim 10 wherein the end condition is fulfilled when a variance of the remaining members is below a variance predefined threshold.

14. The non-transitory computer readable medium according to claim 10 wherein the selecting comprises selecting a first centroid in a random manner and selecting a second centroid based on a distance to the first centroid.

15. The non-transitory computer readable medium according to claim 10 wherein the determining of the item features is executed by a non-item specific neural network, the non-item specific neural network is pre-trained to perform feature extraction of objects, at least some of the objects differ from the item.

16. The non-transitory computer readable medium according to claim 10 that stores instructions for finding reference images out of the reference image candidates.

17. The non-transitory computer readable medium according to claim 16 wherein the determining of the item features is executed by a non-item specific neural network, the non-item specific neural network is pre-trained to perform feature extraction of objects, at least some of the objects differ from the item.

18. The non-transitory computer readable medium according to claim 17 that stores instructions for re-training a non-item specific neural network with the reference images.
